(19) United States
(12) Patent Application Publication
(10) Pub. No.: US 2023/0407906 A1
(43) Pub. Date: Dec. 21, 2023

(54) CABLE COUPLING MECHANISM

(71) Applicant: HI-LEX CORPORATION, Hyogo (JP)

(72) Inventors: Tomoyoshi OKADA, Hyogo (JP); Atsushi NISHIMURA, Hyogo (JP)

(21) Appl. No.: 18/248,881

(22) PCT Filed: Oct. 18, 2021
(86) PCT No.: PCT/JP2021/038381

§ 371 Date: Apr. 13, 2023

(30) Foreign Application Priority Data
Oct. 16, 2020 (JP) 2020-174800

(51) Int. Cl. F16C 1/10

(52) U.S. Cl. CPC F16C 1/101

(57) ABSTRACT

Provided is a cable linking mechanism including: connection target to which cables are connected; case accommodating connection target, wherein, case includes: case body with sliding surface on which connection target slides; lid member capable of closing case body; hinge connecting case body and lid member, case body includes outer wall portions extending so as to protrude outward, lid member includes inner wall portions capable of contacting outer wall portions, outer wall portions are placed outside from inner wall portions in a radial direction of relative rotation, outer wall portions and inner wall portions are placed to restrict a relative movement of lid member with respect to the case body along sliding surface in a direction away from a rotation axis of the relative rotation by contacting each other when a load is applied to case body and/or lid member so that lid member performs the relative movement.

### TECHNICAL FIELD

The present disclosure relates to a cable linking mechanism.

### BACKGROUND ART

The cable linking mechanism disclosed in Patent Literature (hereinafter, referred to as PTL) 1, for example, has been used as a mechanism that links a cable connected to an operation section and a cable connected to an actuation section and transmits the operating force by the operation section to the actuation section via the plurality of cables. Such a cable linking mechanism includes a slider to which the plurality of cables are connected and a slider accommodating member that slidably accommodates the slider. The slider accommodating member includes a bottom side member and a lid side member connected to each other via a hinge, and is configured such that the bottom side member and the lid side member rotate relative to each other around the hinge. In the slider accommodating member, the bottom side member and the lid side member are rotated relative to each other and the bottom side member is closed with the lid side member, thereby forming an accommodation space for accommodating the slider.

In the cable linking mechanism in PTL 1, the lid side member is provided with a wall portion capable of making contact with the outer surface of a side wall of the bottom side member. Thus, even when the bottom side member and the lid side member move relative to each other in the direction perpendicular to the outer surface of the side wall of the bottom side member in a state where the bottom side member is closed with the lid side member, the relative movement is restricted by the contact between the wall portion of the lid side member and the outer surface of the side wall of the bottom side member. This reduces the load on the hinge connecting the bottom side member and the lid side member, and prevents damage to the hinge.

### CITATION LIST

### Patent Literature

### PTL 1

Japanese Patent Application Laid-Open No. 2017-145926

### SUMMARY OF INVENTION

### Technical Problem

Here, the wall portion of the lid side member is provided so as to project from the lid side member toward the bottom side member in a state where the bottom side member is closed with the lid side member. The wall portion of the lid side member is placed inside with respect to the outer surface of the side wall of the bottom side member in the radial direction of the relative rotation of the bottom side member and the lid side member. Thus, in a case where the slider accommodating member is designed so as to reduce the clearance between the wall portion and the outer surface in the state where the bottom side member is closed with the lid side member, the wall portion of the lid side member and the side wall of the bottom side member possibly interfere (collide) with each other when the bottom side member and the lid side member are rotated relative to each other; accordingly, the hinge may be overloaded and damaged. On the contrary, in a case where the slider accommodating member is designed so as to expand the clearance, the above-mentioned relative movement of the bottom side member and the lid side member is possibly not well restricted, for example, when the bottom side member is engaged with the lid side member in order to be closed with the lid side member; accordingly, the hinge may be overloaded and damaged.

It is an object of the present invention to provide a cable linking mechanism capable of preventing damage to a hinge.

### Solution to Problem

A cable linking mechanism of the present invention includes: a connection target to which a cable is connected; and a case with internal space slidably accommodating the connection target, wherein, the case includes: a case body with a sliding surface on which the connection target slides; a lid member capable of closing the case body; and a hinge that connects the case body and the lid member, the case body and the lid member are configured to allow relative rotation with respect to each other about the hinge between an open position where the internal space of the case is open and a closed position where the case body is closed with the lid member, one of the case body and the lid member includes an outer wall portion that protrudes and extends outward from the one of the case body and the lid member to another one of the case body and the lid member when the case body and the lid member are in the closed position, the another one of the case body and the lid member includes an inner wall portion inside in a direction opposite to a direction to the one of the case body and the lid member when the case body and the lid member are in the closed position, the inner wall portion being capable of making contact with the outer wall portion, the outer wall portion is placed outside from the inner wall portion in a radial direction of the relative rotation, and the outer wall portion and the inner wall portion are placed to restrict, by making contact with each other, a relative movement of the lid member with respect to the case body along the sliding surface in a direction away from a rotation axis of the relative rotation when the case body and the lid member are in the closed position and a load is applied to the case body and/or the lid member so that the lid member performs the relative movement.

### Advantageous Effects of Invention

According to the cable linking mechanism of the present invention, it is possible to prevent damage to a hinge.

### BRIEF DESCRIPTION OF DRAWINGS

FIG. 1 is a top view illustrating a case of a cable linking mechanism according to an embodiment of the present invention in the open position;

FIG. 2 is a top view illustrating the case of the cable linking mechanism in FIG. 1 in the closed position;

FIG. 3A is a perspective view of the case of the cable linking mechanism in FIG. 1 in the open position;

FIG. 3B is a fragmentary enlarged view of the case in FIG. 3A;

FIG. 4A is a fragmentary cross sectional view around a hinge of the cable linking mechanism in FIG. 1;

FIG. 4B is a fragmentary cross sectional view around the hinge when a lid member is rotated relative to a case body from the state of FIG. 4A;

FIG. 4C is a fragmentary cross sectional view around the hinge when the lid member is rotated relative to the case body from the state of FIG. 4B;

FIG. 4D is a fragmentary cross sectional view around the hinge when the lid member is rotated relative to the case body from the state of FIG. 4C and the case body and the lid member are in the closed position;

FIG. 5 is a fragmentary cross side view around the hinge of the cable linking mechanism in FIG. 2;

FIG. 6A is a fragmentary cross sectional view around a hinge when a case body and a lid member are in the open position in a conventional cable linking mechanism;

FIG. 6B is a fragmentary cross sectional view around the hinge when the lid member is rotated relative to the case body from the state of FIG. 6A;

FIG. 6C is a fragmentary cross sectional view around the hinge when the lid member is rotated relative to the case body from the state of FIG. 6B; and

FIG. 6D is a fragmentary cross sectional view around the hinge when the lid member is rotated relative to the case body from the state of FIG. 6C and the case body and the lid member are in the closed position.

### DESCRIPTION OF EMBODIMENTS

Hereinafter, a cable linking mechanism according to an embodiment of the present invention will be described in detail with reference to the accompanying drawings. Note that the following embodiment is merely an example, and the cable linking mechanism of the present invention is not limited thereto.

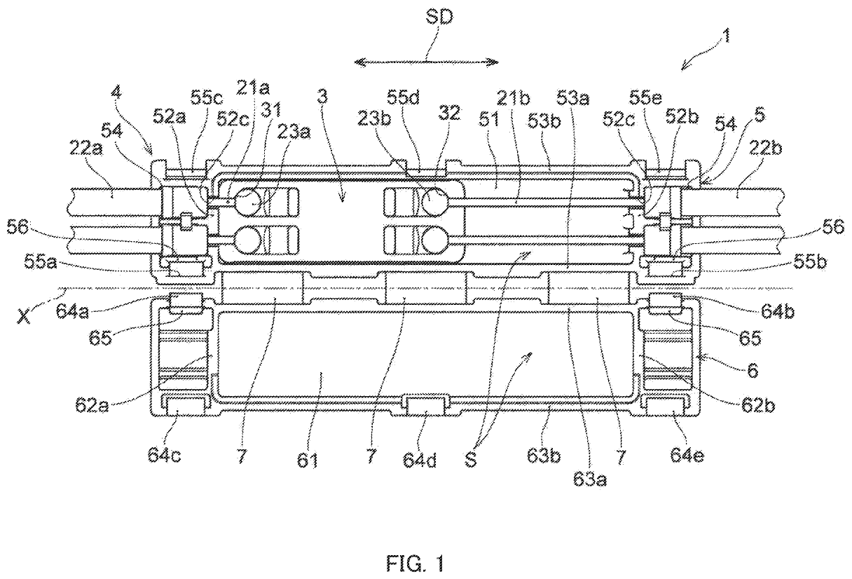

Cable linking mechanism 1 according to the present embodiment is used to link one cable 21a connected to an operation section (not illustrated) and the other cable 21b connected to an actuation section (not illustrated) to transmit the operating force by the operation section to the actuation section, as illustrated in FIG. 1. Cable linking mechanism 1 is used for a seat operation apparatus that operates a seat of a vehicle and an opening/closing apparatus that opens and closes a fuel lid, for example. The use of the cable linking mechanism of the present invention, however, is not particularly limited as long as it links a plurality of cables and transmits the operating force through the plurality of cables, and it can be applied to other uses besides vehicles.

As illustrated in FIG. 1, cable linking mechanism 1 includes connection target 3 to which cables 21a and 21b are connected, and case 4 with inner space S for slidably accommodating connection target 3. Cable linking mechanism 1 links one cable 21a connected to an operation section (not illustrated), such as a seat lever, and the other cable 21b connected to an actuation section (not illustrated), such as a locking mechanism of the seat, via connection target 3. In cable linking mechanism 1, connection target 3 slides in inner space S of case 4 by the operating force transmitted from one cable 21a, and the operating force is transmitted to the other cable 21b, so that the operating force of the operation section is transmitted to the actuation section.

Cables 21a and 21b are long members that connect the operation section and the actuation section to connection target 3 of cable linking mechanism 1 and transmit the operating force of the operation section to the actuation section via connection target 3. In the present embodiment, cables 21a and 21b are embodied as inner cables 21a and 21b that are slidably inserted into outer casings 22a and 22b, as illustrated in FIG. 1. An inner cable and an outer casing of a known control cable can be used as inner cables 21a and 21b and outer casings 22a and 22b. Note that the cables may be any cables as long as they can transmit the operating force and may be ones used without being inserted into the outer casings.

As illustrated in FIG. 1, one cable 21a of cables 21a and 21b connects the operation section (not illustrated) and connection target 3 by one end being connected to connection target 3 of cable linking mechanism 1 and the other end being connected to the operation section. The other cable 21b of cables 21a and 21b connects the actuation section (not illustrated) and connection target 3 by one end being connected to connection target 3 of cable linking mechanism 1 and the other end being connected to the actuation section. Cables 21a and 21b only need to be able to respectively connect the operation section and the actuation section to connection target 3, and the method of connecting the operation section and the actuation section to connection target 3 is not particularly limited. In the present embodiment, one ends of cables 21a and 21b are provided with cable ends 23a and 23b respectively, and the one ends of cables 21a and 21b are connected to connection target 3 via cable ends 23a and 23b respectively. In addition, the other ends of cables 21a and 21b are provided with cable ends (not illustrated) respectively, and those ends of cables 21a and 21b are connected to the operation section and the actuation section via the cable ends respectively.

In the present embodiment, two cables (one side) 21a and two cables (the other side) 21b are provided as illustrated in FIG. 1. The numbers of one cables 21a and the other cables 21b, however, are not particularly limited, and there may be one each of cables 21a and 21b, one cable 21a and a plurality of cables 21b, or a plurality of cables 21a and one cable 21b. It can be appropriately changed according to the use of cable linking mechanism 1.

Outer casings 22a and 22b include inner space through which cables 21a and 21b are slidably inserted, guide inserted cables 21a and 21b along a predetermined routing path, and protect inserted cables 21a and 21b from the outside. As illustrated in FIG. 1, one ends of outer casings 22a and 22b are connected to case 4 of cable linking mechanism 1 and the other ends are connected to the operation section and the actuation section respectively, so that outer casing 22a is routed between the operation section side and cable linking mechanism 1, and outer casing 22b is routed between the actuation section side and cable linking mechanism 1.

Connection target 3 is a member to which one cable 21a and the other cable 21b are connected and which transmits the operating force from one cable 21a to the other cable 21b. As illustrated in FIG. 1, connection target 3 is a slider that is accommodated in inner space S of case 4 and slides along sliding direction SD (in the present embodiment, parallel to rotation axis X to be described later) in inner space S. Connection target 3 slides along sliding direction SD to transmit the operating force from one cable 21a to the other cable 21b. Connection target 3 only needs to be connected to one cable 21a and the other cable 21b so as to transmit the operating force from one cable 21a to the other cable 21b, and the method of connecting one cable 21a and the other cable 21b is not particularly limited. In the present embodiment, one cable 21a and the other cable 21b are connected to connection target 3 by, as illustrated in FIG. 1, cable end 23a of one cable 21a being engaged with one-side engaging section 31 provided on one side (left side in the drawing) of sliding direction SD of connection target 3 and cable end 23b of the other cable 21b being engaged with other-side engaging section 32 provided on the other side (right side in the drawing) of sliding direction SD of connection target 3.

In the present embodiment, connection target 3 is placed so as to slide in inner space S of case 4 along linearly extending sliding direction SD, as illustrated in FIG. 1. Thus, when the operation section pulls one cable 21a to the one side (left side in the drawing), for example, connection target 3 connected to cable 21a via cable end 23a slides to the one side (left side in the drawing) and the other cable 21b connected to connection target 3 via cable end 23b is pulled to the one side (left side in the drawing). Note that the sliding direction of connection target 3 is not particularly limited as long as the operating force is transmitted from one cable 21a to the other cable 21b by connection target 3 sliding in inner space S of case 4, and connection target 3 may be configured to slide along a rotation direction extending in an arc.

Connection target 3 only needs to transmit the operating force from one cable 21a to the other cable 21b by sliding in inner space S of case 4, and the shape and size are not particularly limited. In the present embodiment, connection target 3 has a substantially rectangular parallelepiped shape and the entire shape extends along sliding direction SD, as illustrated in FIG. 1. Connection target 3 is allowed to slide along sliding direction SD in inner space S and the size is formed to restrict the movement in a direction other than sliding direction SD. Further, connection target 3 can be formed of (but not limited to) metal or resin as long as it has a strength for transmitting the operating force from one cable 21a to the other cable 21b. For example, connection target 3 is preferably formed of resin in terms of weight reduction.

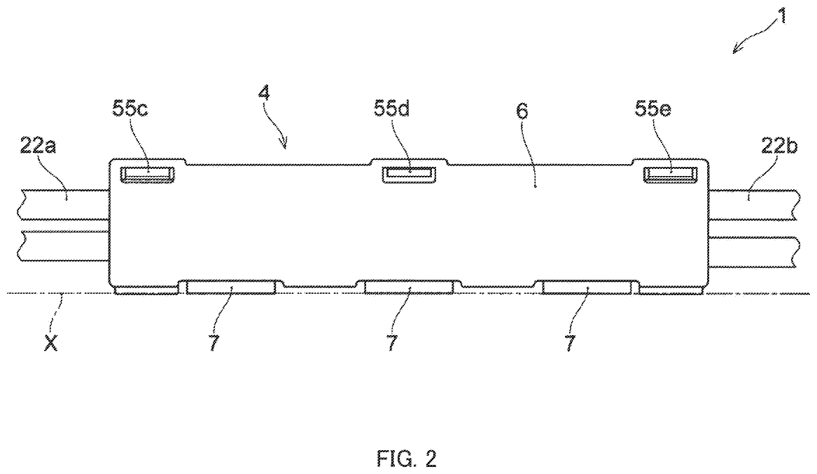

Case 4 is a member having inner space S and slidably accommodating connection target 3 in inner space S. As illustrated in FIG. 1 and FIG. 2, case 4 includes case body 5 having sliding surface 51 on which connection target 3 slides, lid member 6 capable of closing case body 5, and hinges 7 connecting case body 5 and lid member 6. Case body 5 and lid member 6 are configured to be capable of rotating relative to each other about hinges 7 between an open position (position in FIG. 1) where inner space S of case 4 is open and a closed position (position in FIG. 2) where case body 5 is closed with lid member 6. Case 4 forms inner space S where connection target 3 can slide by case body 5 and lid member 6 rotating relative to each other about hinges 7 (rotation axis X) and case body 5 being closed with lid member 6. Note that case 4 can be formed of (but not limited to) metal or resin as long as it has a strength for slidably accommodating connection target 3. For example, it is preferable that case 4 is integrally formed of resin in terms of weight reduction.

Case body 5 is a member composing case 4 with lid member 6 and forming inner space S where connection target 3 can slide by being closed with lid member 6. In addition, case body 5 is a member to which connection target 3 is temporarily attached when not being closed with lid member 6. Case body 5 is connected to lid member 6 via hinges 7 as illustrated in FIG. 1. Case body 5 is closed with lid member 6 by rotating relative to lid member 6 about hinges 7 (rotation axis X), thereby forming inner space S in case 4. Case body 5 only needs to be configured to be closed with lid member 6, and the configuration is not particularly limited. In the present embodiment, case body 5 includes, as illustrated in FIG. 1, sliding surface 51 on which connection target 3 slides, a pair of first and second side walls 52a and 52b erected from both end sides of sliding surface 51 in sliding direction SD, and a pair of third and fourth side walls 53a and 53b erected from both end sides of sliding surface 51 in a direction perpendicular to sliding direction SD. On a side facing sliding surface 51 and perpendicular to sliding surface 51 of case body 5 (hereinafter, also referred to as the height direction of case body 5), an opening defined by upper surfaces (surfaces on the opposite side of sliding surface 51 in the height direction of case body 5) of the pair of first and second side walls 52a and 52b and the pair of third and fourth side walls 53a and 53b is formed. Connection target 3 is inserted into case body 5 through the opening of case body 5 and is temporarily attached to case body 5. Then, the opening of case body 5 is closed with lid member 6; accordingly, the space defined by sliding surface 51, first and second side walls 52a and 52b, and third and fourth side walls 53a and 53b forms at least a part of inner space S. The pair of first and second side walls 52a and 52b are respectively provided with groove-shaped cable guiding sections 52c and 52c for guiding cables 21a and 21b from inner space S to the outside.

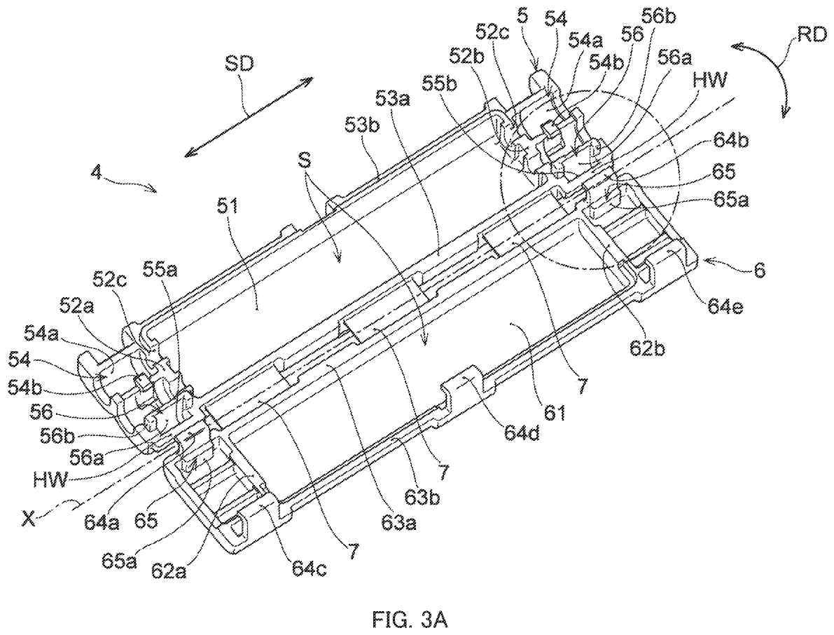

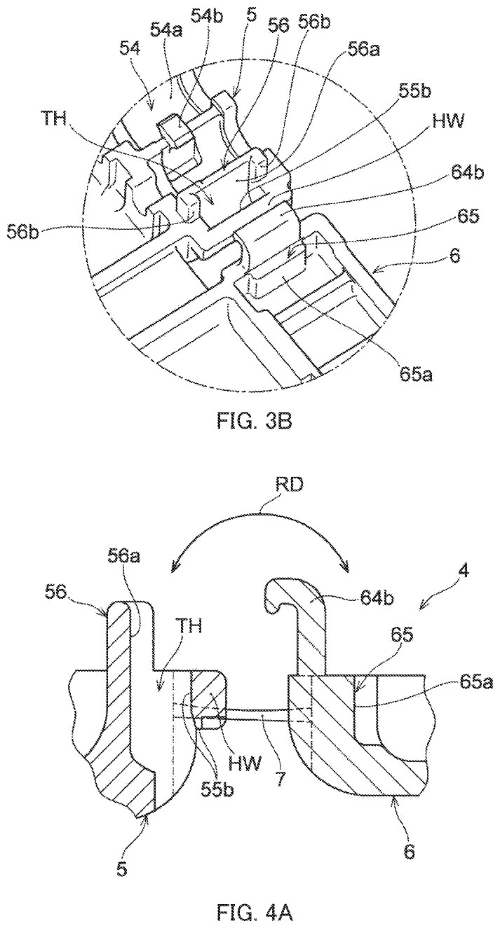

As illustrated in FIG. 1 and FIG. 3A, case body 5 is provided with outer casing fixing sections 54 and 54 to which outer casings 22a and 22b are fixed, on both end sides of sliding direction SD outside of first and second side walls 52a and 52b. Outer casing fixing sections 54 and 54 include concave sections 54a and 54a capable of accommodating the ends of outer casings 22a and 22b (see FIG. 3A). The ends of outer casings 22a and 22b are fixed to outer casing fixing sections 54 and 54 by case body 5 being closed with lid member 6 while the ends of outer casings 22a and 22b are accommodated in concave sections 54a and 54a. The ends of outer casings 22a and 22b are fixed to outer casing fixing sections 54 and 54 by case body 5 being closed with lid member 6 while the ends of outer casings 22a and 22b are accommodated in concave sections 54a and 54a. Outer casing fixing sections 54 and 54 further include detachment prevention ribs 54b and 54b for temporarily fixing the ends of outer casings 22a and 22b to concave sections 54a and 54a by engaging with the outer peripheral surfaces of the ends of outer casings 22a and 22b while case body 5 is not closed with lid member 6 (see FIG. 3A). This facilitates assembly of cables 21a and 21b, outer casings 22a and 22b, and connection target 3 to case body 5.

Case body 5 includes engaged sections 55a to 55e that are engageable with engaging sections 64a to 64e, to be described later, of lid member 6, as illustrated in FIG. 1 and FIG. 3A. Case 4 is kept closed by the engagement of engaging sections 64a to 64e of lid member 6 with engaged sections 55a to 55e of case body 5. Engaged sections 55a to 55e of case body 5 restrict relative movement between case body 5 and lid member 6 while engaged with engaging sections 64a to 64e of lid member 6. To be more specific, as described in detail below, engaged sections 55a to 55e of case body 5 are engaged with engaging sections 64a to 64e of lid member 6 to restrict relative movement of lid member 6 to case body 5 relatively rotating about hinges 7 in a direction away from sliding surface 51 and relative movement of lid member 6 to case body 5 parallel to sliding surface 51 toward the hinge 7 side. Note that, in the present embodiment, engaging sections 64a to 64e are provided in lid member 6 and engaged sections 55a to 55e are provided in case body 5, but the engaging sections may be provided in the case body and the engaged sections may be provided in the lid member.

The provided positions and the numbers of engaged sections 55a to 55e of case body 5 are not particularly limited as long as they are configured to maintain the closed state of case 4 by engaging with engaging sections 64a to 64e of lid member 6. The provided positions and the numbers of engaged sections 55a to 55e can be appropriately set according to the provided positions and the numbers of engaging sections 64a to 64e of lid member 6. In the present embodiment, engaged sections 55a to 55e include, as illustrated in FIG. 1 and FIG. 3A, first engaged section 55a and second engaged section 55b provided on a side close to hinges 7 in a direction perpendicular to the extending direction of rotation axis X, which is hereinafter referred to as rotation axis X direction, and to the height direction of case body 5 (hereinafter, the direction is also referred to as the width direction of case body 5), and third engaged section 55c, fourth engaged section 55d, and fifth engaged section 55e provided on a side far from hinges 7 in the width direction of case body 5. By providing engaged sections 55a to 55e on both sides close to hinges 7 and far from hinges 7 in the direction perpendicular to rotation axis X direction, the closed state of case 4 can be more reliably maintained. Note that, in the present embodiment, two engaged sections 55a and 55b are provided on the side close to hinges 7, and three engaged sections 55c to 55e are provided on the side far from hinges 7, but the numbers of the engaged sections are not particularly limited.

In the present embodiment, first and second engaged sections 55a and 55b are provided at the ends on a side where hinges 7 are provided in the width direction of case body 5, as illustrated in FIG. 1 and FIG. 3A. To be more specific, first and second engaged sections 55a and 55b are provided on third side wall 53a of case body 5. Providing first and second engaged sections 55a and 55b adjacent to hinges 7 not only maintains the closed state of case 4 but also restricts the relative movement between case body 5 and lid member 6 about hinges 7, reduces the load applied to hinges 7, and prevents damage to hinges 7. In the present embodiment, first and second engaged sections 55a and 55b are provided on both end sides of third side wall 53a in rotation axis X direction. To be more specific, first and second engaged sections 55a and 55b are provided on the end sides of third side wall 53a outside of first and second side walls 52a and 52b in rotation axis X direction (both ends of rotation axis X direction of case body 5), adjacent to outer casing fixing sections 54 and 54. Providing first and second engaged sections 55a and 55b on both end sides of third side wall 53a in rotation axis X direction more reliably restricts the relative movement between case body 5 and lid member 6 about hinges 7, reduces the load applied to hinges 7, and prevents damage to hinges 7.

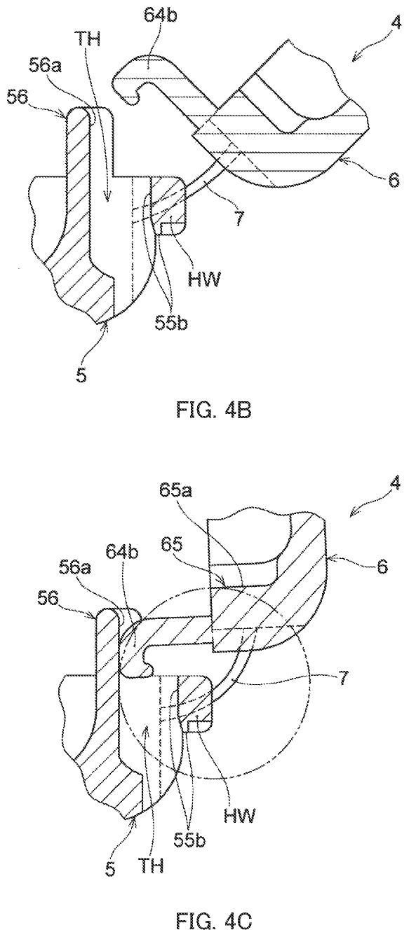

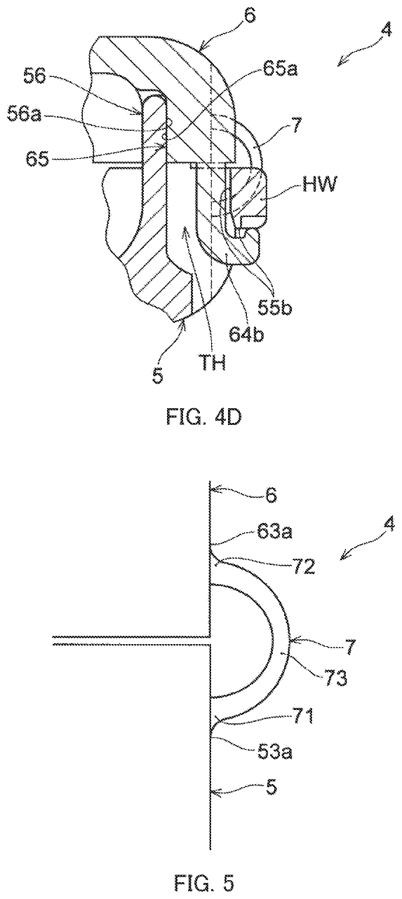

First and second engaged sections 55a and 55b only need to be engaged with corresponding first and second engaging sections 64a and 64b of lid member 6 so as to restrict the relative movement between case body 5 and lid member 6, and the configuration thereof is not particularly limited. In the present embodiment, first and second engaged sections 55a and 55b are each provided inside case body 5 in a direction opposite to the direction toward lid member 6 while case body 5 and lid member 6 are in the closed position (position in FIG. 2) as illustrated in FIG. 1 and FIG. 3A. The term “inside case body 5” as used herein means a side perpendicular to a plane formed by the upper surfaces of side walls (first to fourth side walls 52a, 52b, 53a, and 53b) of case body 5, which define the opening of case body 5, and opposite to a direction in which the plane formed by the upper surfaces of the side walls of case body 5 faces lid member 6 (that is, lower side in FIG. 3A). Thus, first and second engaged sections 55a and 55b are each provided inside case body 5 in the height direction with respect to the plane formed by the upper surfaces of the side walls defining the opening of case body 5. To be more specific, first and second engaged sections 55a and 55b are each configured by a part of a frame body surrounding the concave section (in the present embodiment, through hole TH (see FIG. 3B) penetrating in the height direction of case body 5). The part of the frame body is hinge-side wall portion HW composing the frame body on the hinge 7 side in the width direction of case body 5, and more specifically, an inner surface of hinge-side wall portion HW facing through hole TH (surface facing away from the hinge 7 side in the width direction of case body 5) and a lower surface of hinge-side wall portion HW (surface facing the sliding surface 51 side in the height direction of case body 5) (see FIG. 4A to FIG. 4D). As illustrated in FIG. 4D, engagement of first and second engaging sections 64a and 64b of lid member 6 with the lower surface of hinge-side wall portion HW restricts relative movement of lid member 6 rotating relative to case body 5 about hinges 7 in a direction away from sliding surface 51. Further, engagement of first and second engaging sections 64a and 64b of lid member 6 with the inner surface of hinge-side wall portion HW restricts relative movement of lid member 6 to case body 5 toward the hinge 7 side in the width direction. Note that first and second engaged sections 55a and 55b have the same configuration in the present embodiment, but may have configurations different from each other. Further, in the present embodiment, first and second engaged sections 55a and 55b are provided inside case body 5 in a direction opposite to a direction toward lid member 6, but in a case of being provided in lid member 6, they are provided inside lid member 6 in a direction opposite to a direction toward case body 5.

In the present embodiment, third to fifth engaged sections 55c to 55e are provided at an end of case body 5 on a side opposite to the side where hinges 7 are provided in the width direction, as illustrated in FIG. 1. To be more specific, third to fifth engaged sections 55c to 55e are provided on fourth side wall 53b of case body 5. Since third to fifth engaged sections 55c to 55e are provided on a side opposite to the side where hinges 7 are provided, it is possible to more reliably restrict relative rotation between case body 5 and lid member 6 from the closed position (position in FIG. 2) to the open position (position in FIG. 1) and to maintain the closed state of case 4. In the present embodiment, third to fifth engaged sections 55c to 55e are provided on both end sides of fourth side wall 53b in rotation axis X direction and on a substantially intermediate position between both ends. To be more specific, third and fifth engaged sections 55c and 55e are provided on the end sides of fourth side wall 53b outside of first and second side walls 52a and 52b in rotation axis X direction (both ends of rotation axis X direction of case body 5), adjacent to outer casing fixing sections 54 and 54. In addition, fourth engaged section 55d is provided at a substantially intermediate position between both ends of fourth side wall 53b in rotation axis X direction. Third to fifth engaged sections 55c to 55e are placed in a row at substantially equal intervals along rotation axis X direction. Placing third to fifth engaged sections 55c to 55e in a row between both ends of fourth side wall 53b along rotation axis X direction more reliably restricts relative rotation between case body 5 and lid member 6 and maintains the closed state of case 4.

Third to fifth engaged sections 55c to 55e only need to be engaged with corresponding third to fifth engaging sections 64c to 64e of lid member 6 so as to restrict the relative rotation between case body 5 and lid member 6, and the configuration thereof is not particularly limited. In the present embodiment, third to fifth engaged sections 55c to 55e are configured as protruding sections that protrude from fourth side wall 53b of case body 5 toward the outside of the side opposite to the side where hinges 7 are provided in the width direction of case body 5. Third to fifth engaged sections 55c to 55e configured as protruding sections form a snap-fit structure together with corresponding third to fifth engaging sections 64c to 64e of lid member 6. Note that third to fifth engaged sections 55c to 55e have the same configuration in the present embodiment, but may have configurations different from each other.

As illustrated in FIG. 1, FIG. 3A, and FIG. 3B, case body 5 includes outer wall portions 56 that protrude and extend outside case body 5 toward lid member 6 from case body 5 when case body 5 and lid member 6 are in the closed position (position in FIG. 2). The term “outside case body 5” as used herein means a side perpendicular to a plane formed by the upper surfaces of side walls (first to fourth side walls 52a, 52b, 53a, and 53b) of case body 5, which define the opening of case body 5, and in a direction toward lid member 6 from the plane formed by the upper surfaces of the side walls of case body 5 (that is, upper side in FIG. 3A). That is, outer wall portions 56 protrude and extend outside case body 5 in the height direction (upper side in FIG. 3A and FIG. 3B) from the plane formed by the upper surfaces of the side walls defining the opening of case body 5. Outer wall portions 56 are placed so as to make contact with inner wall portions 65, which is to be described later, of lid member 6 (see FIG. 4D) and restrict relative movement between case body 5 and lid member 6. To be more specific, outer wall portions 56 and inner wall portions 65 are placed so as to make contact with each other to restrict relative movement of lid member 6 when case body 5 and lid member 6 are in the closed position and a load is applied to case body 5 and/or lid member 6 so that lid member 6 moves relative to case body 5 along sliding surface 51 in a direction away from rotation axis X of relative rotation. The contact of outer wall portions 56 of case body 5 with inner wall portions 65 of lid member 6 restricts the relative movement of lid member 6 to case body 5 in a direction away from rotation axis X (hinges 7) in the width direction of case body 5, reduces the load applied to hinges 7, and prevents damage to hinges 7. For example, a load causing lid member 6 to move relative to case body 5 in a direction away from rotation axis X (hinges 7) is sometimes applied by the snap-fit engagement between third to fifth engaged sections 55c to 55e of case body 5 and third to fifth engaging sections 64c to 64e of lid member 6 when case body 5 and lid member 6 engage with each other. In particular, the lower the temperature of the environment in which cable linking mechanism 1 is placed, the less likely third to fifth engaging sections 64c to 64e and third to fifth engaged sections 55c to 55e deform during the snap-fit engagement, and thus the greater the load causing lid member 6 to move relative to case body 5 becomes. Even in such a case, the contact of outer wall portions 56 with inner wall portions 65 restricts the relative movement between case body 5 and lid member 6, reduces the load applied to hinges 7, and prevents damage to hinges 7. Note that, in the present embodiment, outer wall portions 56 are provided in case body 5 and inner wall portions 65 are provided in lid member 6, but the outer wall portions may be provided in the lid member and the inner wall portions may be provided in the case body. In this case, the outer wall portions are provided so as to protrude and extend outside the lid member.

The provided positions and the number of outer wall portions 56 are not particularly limited as long as they can restrict the above-described relative movement between case body 5 and lid member 6 by making contact with inner wall portions 65 of lid member 6. In the present embodiment, outer wall portions 56 are provided on the end sides of the side where hinges 7 are provided in the width direction of case body 5, as illustrated in FIG. 1 and FIG. 3A. To be more specific, outer wall portions 56 are provided adjacent to third side wall 53a of case body 5. Providing outer wall portions 56 adjacent to hinges 7 more reliably restricts the relative movement between case body 5 and lid member 6 about hinges 7, thereby reducing the load applied to hinges 7 and preventing damage to hinges 7. One outer wall portion 56 is provided adjacent to each of both end sides of third side wall 53a in rotation axis X direction. To be more specific, outer wall portions 56 are provided on the end sides of third side wall 53a outside of first and second side walls 52a and 52b in rotation axis X direction (both ends of rotation axis X direction of case body 5), adjacent to outer casing fixing sections 54 and 54. Providing outer wall portions 56 on both end sides of third side wall 53a in rotation axis X direction restricts distortion of lid member 6 against case body 5 along sliding surface 51, thereby more reliably reducing the load applied to hinges 7 and preventing damage to hinges 7. Especially in the present embodiment, as illustrated in FIG. 1 and FIG. 3A, outer wall portions 56 are provided at positions respectively overlapping first and second engaged sections 55a and 55b and third to fifth engaged sections 55c to 55e over a predetermined area in rotation axis X direction when viewed in the direction perpendicular to rotation axis X direction (width direction of case body 5) when case body 5 and lid member 6 in the closed position. That is, outer wall portions 56 are provided on substantially the same positions in rotation axis X direction as first and second engaged sections 55a and 55b and third to fifth engaged sections 55c to 55e. Thus, for example, even in a case where a load is applied to case body 5 and/or lid member 6 so that lid member 6 moves relative to case body 5 along sliding surface 51 in a direction away from rotation axis X when first and second engaged sections 55a and 55b and third and fifth engaged section 55c and 55e engage with corresponding first and second engaging sections 64a and 64b and third and fifth engaging sections 64c and 64e of lid member 6, distortion of lid member 6 against case body 5 along sliding surface 51 is restricted, thereby more reliably reducing the load applied to hinges 7 and preventing damage to hinges 7.

The shape of outer wall portion 56 is not particularly limited as long as it can restrict the above-described relative movement between case body 5 and lid member 6 by making contact with inner wall portion 65 of lid member 6. In the present embodiment, outer wall portion 56 is formed such that contact surface 56a with inner wall portion 65 is substantially parallel to rotation axis X direction and extends substantially perpendicular to sliding surface 51, as illustrated in FIG. 3A and FIG. 3B. That is, when case body 5 and lid member 6 are in the closed position (position in FIG. 2), contact surface 56a of outer wall portion 56 with inner wall portion 65 is in a position facing contact surface 65a of inner wall portion 65, and is substantially perpendicular to the direction in which lid member 6 moves relative to case body 5 in the width direction of case body 5 and which is away from rotation axis X (hinge 7). This enables maximum opposition to the load causing the above-described relative movement between case body 5 and lid member 6, thus more reliably reducing the load applied to hinges 7 and preventing damage to hinges 7.

Outer wall portion 56 may include ribs 56b extending along the direction in which outer wall portion 56 extends, as illustrated in FIG. 3A and FIG. 3B. Providing ribs 56b to outer wall portion 56 strengthens outer wall portion 56 and makes outer wall portion 56 higher. This more reliably restricts the above-described movement of case body 5 and lid member 6 relative to each other, and prevents damage to hinges 7. Ribs 56b may be placed in any way as long as they are provided so as to extend along the direction in which outer wall portion 56 extends. In the present embodiment, a pair of ribs 56b are provided at both ends of outer wall portion 56 in rotation axis X direction so as to extend parallel to each other. The pair of ribs 56b and 56b are apart from each other by a distance corresponding to the width of inner wall portion 65 of lid member 6 in rotation axis X direction. The pair of ribs 56b and 56b restrict the relative movement between case body 5 and lid member 6 along rotation axis X direction by making contact with both side surfaces of inner wall portion 65 in rotation axis X direction. This also reduces the load applied to hinges 7 and prevents damage to hinges 7.

In addition to the function of restricting the above-described relative movement between case body 5 and lid member 6 by making contact with inner wall portions 65 of lid member 6, outer wall portions 56 may have a function of guiding engaging sections 64a and 64b (first and second engaging sections 64a and 64b) of lid member 6 to engaged sections 55a and 55b (first and second engaged sections 55a and 55b) of case body 5. In the present embodiment, as illustrated in FIG. 3A and FIG. 3B, outer wall portions 56 are placed to guide engaging sections 64a and 64b to engaged sections 55a and 55b while restricting the movement of lid member 6 relative to case body 5 along sliding surface 51 in the direction away from rotation axis X by making contact with engaging sections 64a and 64b (see FIG. 4C) when case body 5 and lid member 6 are rotated relative to each other from the open position (position in FIG. 1) to the closed position (position in FIG. 2). This prevents lateral shift of case body 5 and lid member 6 in the width direction with respect to each other during the relative rotation of case body 5 and lid member 6, thereby reducing the load applied to hinges 7 and preventing damage to hinges 7.

In the present embodiment, outer wall portion 56 constitutes another part of a frame including hinge-side wall portion HW that forms engaged section 55a or 55b of case body 5, as illustrated in FIG. 3A and FIG. 3B. To be more specific, outer wall portion 56 is placed so as to face through hole TH in a position facing hinge-side wall portion HW that forms engaged section 55a or 55b in a direction perpendicular to rotation axis X direction (width direction of case body 5). As illustrated in FIG. 4A, outer wall portion 56 extends from a position protruding outside case body 5 relative to hinge-side wall portion HW to a position entering inside case body 5 relative to hinge-side wall portion HW, and then is curved toward the engaged section 55a or 55b side. This allows engaging sections 64a and 64b of lid member 6 to be more reliably guided to engaged sections 55a and 55b respectively through through holes TH when case body 5 and lid member 6 rotate relative to each other and engaging sections 64a and 64b pass through through holes TH and engage with engaged sections 55a and 55b respectively.

The spacing between the above-described pair of ribs 56b and 56b of outer wall portion 56 in rotation axis X direction may correspond to the length of engaging section 64a or 64b of lid member 6 in rotation axis X direction. As a result, when engaging sections 64a and 64b make contact with outer wall portions 56, both side surfaces of engaging sections 64a and 64b in rotation axis X direction make contact with the pair of ribs 56b and 56b; accordingly, the movement in rotation axis X direction is restricted and engaging sections 64a and 64b are guided to engaged sections 55a and 55b respectively. As the relative movement between case body 5 and lid member 6 along rotation axis X direction during the relative rotation of case body 5 and lid member 6 is restricted, distortion of case body 5 and lid member 6 relative to each other is prevented. This reduces the load applied to hinges 7 and prevents damage to hinges 7.

Lid member 6 is a member that constitutes case 4 together with case body 5 and closes case body 5. Lid member 6 is connected to case body 5 via hinges 7 as illustrated in FIG. 1 and FIG. 2. Lid member 6 closes case body 5 by rotating relative to case body 5 about hinges 7 (rotation axis X), thereby forming inner space S in case 4. Lid member 6 only needs to be able to close case body 5, and the configuration thereof is not particularly limited. In the present embodiment, lid member 6 includes facing surface 61 that faces sliding surface 51 of case body 5 when case body 5 and lid member 6 are in the closed position (position in FIG. 1), a pair of fifth and sixth side walls 62a and 62b erected from both end sides of facing surface 61 in sliding direction SD, and a pair of seventh and eighth side walls 63a and 63b erected from both end sides of facing surface 61 in a direction perpendicular to sliding direction SD. On a side facing facing surface 61 and perpendicular to facing surface 61 of lid member 6 (hereinafter, also referred to as the height direction of lid member 6), an opening defined by upper surfaces (surfaces on the opposite side of facing surface 61 in the height direction of lid member 6) of the pair of fifth and sixth side walls 62a and 62b and the pair of seventh and eighth side walls 63a and 63b is formed. The pair of fifth and sixth side walls 62a and 62b are respectively provided in positions corresponding to the pair of first and second side walls 52a and 52b of case body 5, and the pair of seventh and eighth side walls 63a and 63b are respectively provided in positions corresponding to the pair of third and fourth side walls 53a and 53b of case body 5. When case body 5 and lid member 6 are in the closed position, the pair of first and second side walls 52a and 52b of case body 5 make contact with the pair of fifth and sixth side walls 62a and 62b of lid member 6 respectively, and the pair of third and fourth side walls 53a and 53b of case body 5 make contact with the pair of seventh and eighth side walls 63a and 63b of lid member 6 respectively. When case body 5 and lid member 6 are in the closed position, space defined by facing surface 61, fifth and sixth side walls 62a and 62b, and seventh and eighth side walls 63a and 63b of lid member 6 forms inner space S together with space defined by sliding surface 51, first and second side walls 52a and 52b, and third and fourth side walls 53a and 53b of case body 5. Note that lid member 6 only needs to be able to close case body 5, and need not include side walls, for example.

Lid member 6 includes engaging sections 64a to 64e that engage with case body 5 as illustrated in FIG. 1 and FIG. 3A. As described above, engaging sections 64a to 64e of lid member 6 restrict the movement of case body 5 and lid member 6 relative to each other by engaging with engaged sections 55a to 55e of case body 5, and keep case 4 closed. The provided positions and the numbers of engaging sections 64a to 64e of lid member 6 are not particularly limited as long as they are configured to maintain the closed state of case 4 by engaging with engaged sections 55a to 55e of case body 5. In the present embodiment, corresponding to engaged sections 55a to 55e of case body 5, engaging sections 64a to 64e includes first engaging section 64a and second engaging section 64b provided on a side close to hinges 7 in a direction perpendicular to the height direction of lid member 6 and rotation axis X direction (hereinafter, referred to as the width direction of lid member 6), and third engaging section 64c, fourth engaging section 64d, and fifth engaging section 64e provided on a side far from hinges 7 in the width direction of lid member 6. As described above, in the present embodiment, engaging sections 64a to 64e are provided in lid member 6 and engaged sections 55a to 55e are provided in case body 5, but the engaging sections may be provided in the case body and the engaged sections may be provided in the lid member.

In the present embodiment, first and second engaging sections 64a and 64b are provided at the ends on a side where hinges 7 are provided in the width direction of lid member 6, as illustrated in FIG. 1 and FIG. 3A. To be more specific, first and second engaging sections 64a and 64b are provided on seventh side wall 63a of lid member 6. Providing first and second engaging sections 64a and 64b adjacent to hinges 7 not only maintains the closed state of case 4 but also restricts the relative movement between case body 5 and lid member 6 about hinges 7, reduces the load applied to hinges 7, and prevents damage to hinges 7. First and second engaging sections 64a and 64b are provided on both end sides of seventh side wall 63a in rotation axis X direction. More specifically, first and second engaging sections 64a and 64b are provided on the end sides of seventh side wall 63a outside of fifth and sixth side walls 62a and 62b in rotation axis X direction (both ends of lid member 6 in rotation axis X direction).

First and second engaging sections 64a and 64b only need to be engaged with corresponding first and second engaged sections 55a and 55b of case body 5 so as to restrict the relative movement between case body 5 and lid member 6, and the configuration thereof is not particularly limited. In the present embodiment, first and second engaging sections 64a and 64b protrude and extend outside lid member 6 from lid member 6 to case body 5 when case body 5 and lid member 6 are in the closed position (position in FIG. 2), as illustrated in FIG. 1 and FIG. 3A. The term “outside lid member 6” as used herein means a side perpendicular to a plane formed by the upper surfaces of side walls (fifth to eighth side walls 62a, 62b, 63a, and 63b) of lid member 6, which define the opening of lid member 6, and in a direction toward case body 5 from the plane formed by the upper surfaces of the side walls of lid member 6 (that is, upper side in FIG. 3A). Note that facing surface 61 serves as the plane in a case where lid member 6 includes no side walls. That is, first and second engaging sections 64a and 64b protrude and extend outside lid member 6 in the height direction (upper side in FIG. 3A) from the plane formed by the upper surfaces of the side walls defining the opening of lid member 6 (facing surface 61 serves as the plane in a case where lid member 6 includes no side walls). To be more specific, each of first and second engaging sections 64a and 64b extends outside lid member 6 in the height direction of lid member 6 and then curves and extends toward the hinge 7 side in a direction perpendicular to rotation axis X direction (width direction of lid member 6), which forms a claw shape. Each of first and second engaging sections 64a and 64b is configured to be inserted into through hole TH in a frame including hinge-side wall portion HW that forms first and second engaged sections 55a and 55b of case body 5 when case body 5 and lid member 6 rotate relative to each other from the open position (position in FIG. 1) to the closed position (position in FIG. 2). After first and second engaging sections 64a and 64b are inserted into through holes TH, portions of first and second engaging sections 64a and 64b that extend outside lid member 6 in the height direction of lid member 6 are engageable with the inner surfaces of hinge-side wall portions HW, and portions of first and second engaging sections 64a and 64b that curve and extend toward the hinge 7 side are engageable with the lower surfaces of hinge-side wall portions HW (see FIG. 4D).

As illustrated in FIG. 4A to FIG. 4D, first and second engaging sections 64a and 64b are placed (see FIG. 4D) so as to make contact with outer wall portions 56 of case body 5 when lid member 6 moves relative to case body 5 in the width direction of case body 5 and away from rotation axis X (hinges 7) during the relative rotation between case body 5 and lid member 6 from the open position (position in FIG. 1) to the closed position (position in FIG. 2). When first and second engaging sections 64a and 64b make contact with outer wall portions 56 of case body 5, lid member 6 is restricted from moving relative to case body 5 in the width direction of case body 5 and away from rotation axis X (hinges 7), and first and second engaging sections 64a and 64b are guided to first and second engaged sections 55a and 55b of case body 5. Here, first and second engaging sections 64a and 64b are curved along rotation direction RD of the relative rotation between case body 5 and lid member 6, as illustrated in FIG. 4A. To be more specific, each of first and second engaging sections 64a and 64b extends outside lid member 6 in the height direction of lid member 6, and then extends toward the hinge 7 side in a direction perpendicular to rotation axis X direction (width direction of lid member 6) so as to be curved along rotation direction RD of the relative rotation. Further, each of first and second engaging sections 64a and 64b extends toward the hinge 7 side in the direction perpendicular to rotation axis X direction, and then extends inside lid member 6 in the height direction of lid member 6 so as to be curved along rotation direction RD of the relative rotation. When case body 5 and lid member 6 rotate relative to each other from the open position to the closed position, first and second engaging sections 64a and 64b curve along rotation direction RD of the relative rotation, and thus first and second engaging sections 64a and 64b are able to rotate smoothly while in contact even if first and second engaging sections 64a and 64b make contact with outer wall portions 56 of case body 5. Thereby, the relative rotation between case body 5 and lid member 6 can be smoothly performed and damage to the hinges is prevented as a result. Note that first and second engaging sections 64a and 64b have the same configuration in the present embodiment but may have configurations different from each other. In addition, first and second engaging sections 64a and 64b protrude and extend outside lid member 6 toward case body 5 in the present embodiment, but they are provided so as to protrude and extend outside case body 5 toward lid member 6 when provided in case body 5.

In the present embodiment, third to fifth engaging sections 64c to 64e are provided at the ends on a side opposite to the side where hinges 7 are provided in the width direction of lid member 6, as illustrated in FIG. 1 and FIG. 3A. To be more specific, third to fifth engaging sections 64c to 64e are provided on eighth side wall 63b of lid member 6. Third to fifth engaging sections 64c to 64e are provided on the side opposite to the side where hinges 7 are provided, so that it is possible to restrict the relative rotation more reliably between case body 5 and lid member 6 from the closed position (position in FIG. 2) to the open position (position in FIG. 1) and to maintain the closed state of case 4. In the present embodiment, third to fifth engaging sections 64c to 64e are provided on both end sides of eighth side wall 63b in rotation axis X direction and on a substantially intermediate position between both ends. More specifically, third and fifth engaging sections 64c and 64e are provided on the end sides of eighth side wall 63b outside of fifth and sixth side walls 62a and 62b in rotation axis X direction (both ends of lid member 6 in rotation axis X direction). In addition, fourth engaging section 64d is provided at a substantially intermediate position between both ends of eighth side wall 63b in rotation axis X direction. Third to fifth engaging sections 64c to 64e are placed in a row at substantially equal intervals along rotation axis X direction. Placing third to fifth engaging sections 64c to 64e in a row between both ends of eighth side wall 63b along rotation axis X direction more reliably restricts the relative rotation between case body 5 and lid member 6 and maintains the closed state of case 4.

Third to fifth engaging sections 64c to 64e only need to be engaged with corresponding third to fifth engaged sections 55c to 55e of case body 5 so as to restrict the relative movement between case body 5 and lid member 6, and the configuration thereof is not particularly limited. In the present embodiment, third to fifth engaging sections 64c to 64e have a configuration similar to that of first and second engaged sections 64a and 64b, and form a snap-fit structure together with corresponding third to fifth engaged sections 55c to 55e of case body 5. Note that third to fifth engaging sections 64c to 64e have the same configuration in the present embodiment but may have configurations different from each other.

As illustrated in FIG. 1, FIG. 3A, and FIG. 3B, lid member 6 includes inner wall portions 65 that can make contact with outer wall portions 56 of case body 5, inside lid member 6, which is in a direction opposite to the direction toward case body 5, when case body 5 and lid member 6 are in the closed position (position in FIG. 2). The term “inside lid member 6” as used herein means a side perpendicular to a plane formed by the upper surfaces of side walls (fifth to eighth side walls 62a, 62b, 63a, and 63b) of lid member 6 which define the opening of lid member 6, and opposite to a direction toward case body 5 from the plane formed by the upper surfaces of the side walls of lid member 6 (that is, lower side in FIG. 3A). Note that facing surface 61 serves as the plane in a case where lid member 6 includes no side walls. That is, inner wall portions 65 are provided inside lid member 6 in the height direction (lower side in FIG. 3A and FIG. 3B) from the plane formed by the upper surfaces of the sidewalls defining the opening of lid member 6 (facing surface 61 serves as the plane in a case where lid member 6 includes no side walls). Inner wall portions 65 are placed so as to make contact with outer wall portions 56 and restrict the relative movement of lid member 6 when case body 5 and lid member 6 are in the closed position and a load is applied to case body 5 and/or lid member 6 so that lid member 6 moves relative to case body 5 in the width direction of case body 5 and away from rotation axis X. Thus, the contact of inner wall portions 65 with outer wall portions 56 of case body 5 prevents lid member 6 from moving relative to case body 5 in the width direction of case body 5 and away from rotation axis X (hinges 7), reduces the load applied to hinges 7, and prevents damage to hinges 7. Note that, in the present embodiment, outer wall portions 56 are provided in case body 5 and inner wall portions 65 are provided in lid member 6, but the outer wall portions may be provided in the lid member and the inner wall portions may be provided in the case body, as already described above. In this case, the inner wall portions are provided inside the case body.

The provided positions and the number of inner wall portions 65 are not particularly limited as long as they can restrict the above-described relative movement between case body 5 and lid member 6 by making contact with outer wall portions 56 of case body 5. In the present embodiment, inner wall portions 65 are provided on the end sides of the side where hinges 7 are provided in the width direction of lid member 6, as illustrated in FIG. 1 and FIG. 3A. To be more specific, inner wall portions 65 are provided adjacent to seventh side wall 63a of lid member 6. Providing inner wall portions 65 adjacent to hinges 7 more reliably restricts the relative movement between case body 5 and lid member 6 about hinges 7, thereby reducing the load applied to hinges 7 and preventing damage to hinges 7. One inner wall portion 65 is provided adjacent to each of both end sides of seventh side wall 63a in rotation axis X direction. More specifically, inner wall portions 65 are provided adjacent to the end sides of seventh side wall 63a outside of first and second side walls 52a and 52b in rotation axis X direction (both ends of lid member 6 in rotation axis X direction). Providing inner wall portions 65 on both end sides of seventh side wall 63a in rotation axis X direction restricts distortion of lid member 6 against case body 5 along sliding surface 51, thereby more reliably reducing the load applied to hinges 7 and preventing damage to hinges 7. Especially in the present embodiment, as illustrated in FIG. 1 and FIG. 3A, inner wall portions 65 are provided at positions respectively overlapping first and second engaging sections 64a and 64b and third and fifth engaging sections 64c and 64e over a predetermined area in rotation axis X direction when viewed in the direction perpendicular to rotation axis X direction (width direction of lid member 6) when case body 5 and lid member 6 in the closed position. That is, inner wall portions 65 are provided on substantially the same positions in rotation axis X direction as first and second engaging sections 64a and 64b and third and fifth engaging sections 64c and 64e. Thus, for example, even in a case where a load is applied to case body 5 and/or lid member 6 so that lid member 6 moves relative to case body 5 along sliding surface 51 in a direction away from rotation axis X when first and second engaging sections 64a and 64b and third and fifth engaging sections 64c and 64e engage with corresponding first and second engaged sections 55a and 55b and third and fifth engaged section 55c and 55e of case body 5, distortion of lid member 6 against case body 5 along sliding surface 51 is restricted, thereby more reliably reducing the load applied to hinges 7 and preventing damage to hinges 7.

The shape of inner wall portion 65 is not particularly limited as long as it can restrict the above-described relative movement between case body 5 and lid member 6 by making contact with outer wall portion 56 of case body 5. In the present embodiment, inner wall portion 65 is formed such that contact surface 65a with outer wall portion 56 is parallel to rotation axis X direction and extends substantially perpendicular to facing surface 61. That is, when case body 5 and lid member 6 are in the closed position (position in FIG. 2), contact surface 65a of inner wall portion 65 with outer wall portion 56 is in a position facing contact surface 56a of outer wall portion 56, and is substantially perpendicular to the direction in which lid member 6 moves relative to case body 5 in the width direction of case body 5 and away from rotation axis X (hinge 7). This enables maximum opposition to the load causing the above-described relative movement between case body 5 and lid member 6, thus more reliably reducing the load applied to hinges 7 and preventing damage to hinges 7.

Hinge 7 is a member that connects case body 5 and lid member 6 so that case body 5 and lid member 6 are rotatable relative to each other about hinge 7. The configuration of hinge 7 is not particularly limited as long as it can connect case body 5 and lid member 6 so as to be relatively rotatable. For example, in the present embodiment, hinge 7 includes three hinges placed in a row at substantially equal intervals along rotation axis X direction, as illustrated in FIG. 1 and FIG. 3A. At least one hinge needs to be provided, and the number thereof is not particularly limited.

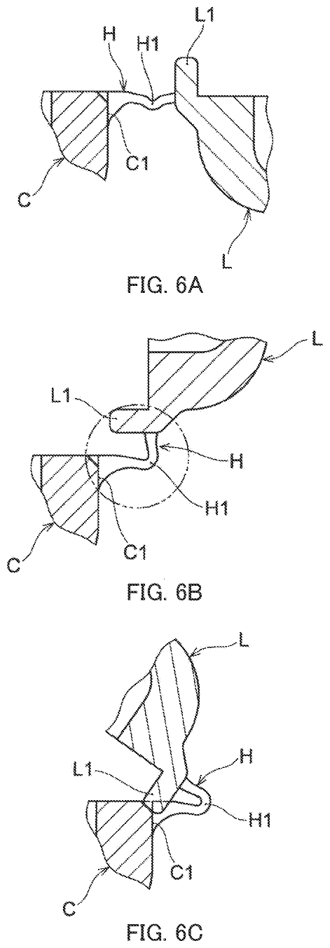

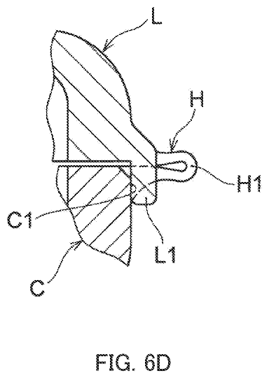

In the present embodiment, as illustrated in FIG. 5, each of hinges 7 includes case-body-side end 71 connected to case body 5, lid-member-side end 72 connected to lid member 6, and body portion 73 extending between case-body-side end 71 and lid-member-side end 72. Case-body-side end 71 is connected to third side wall 53a provided with first and second engaged sections 55a and 55b of case body 5, and lid-member-side end 72 is connected to seventh side wall 63a provided with first and second engaging sections 64a and 64b of lid member 6. Body portion 73 of hinge 7 is formed to be curved over substantially the entire portion between case-body-side end 71 and lid-member-side end 72 when case body 5 and lid member 6 rotate relative to each other. Hinges are typically formed so that only the center part between both ends is bent (see, for example, FIG. 6A to FIG. 6D). In this case, as the case body and the lid member repeat the relative rotation and the open/close operation, the load is concentrated in the center part between both ends, which makes the center part easily damaged. In the present embodiment, however, body portion 73 is curved over substantially the entire portion between case-body-side end 71 and lid-member-side end 72, and thus it is possible to prevent local loading on a particular part and prevent damage. From a similar point of view, body portion 73 is preferably formed to be curved with substantially the same curvature over substantially the entire portion between case-body-side end 71 and lid-member-side end 72. This allows the load received by body portion 73 to be distributed over the entire portion in the length direction, thereby more reliably preventing damage caused by the local loading.

Body portion 73 of hinge 7 only needs to be formed so as to be curved over substantially the entire portion between case-body-side end 71 and lid-member-side end 72, and the configuration thereof is not particularly limited. In the present embodiment, as illustrated in FIG. 1, FIG. 3A, and FIG. 5, body portion 73 is formed in a plate shape as a whole and formed to become continuously thinner at an approximately constant rate from case-body-side end 71 and lid-member-side end 72 toward the center part between case-body-side end 71 and lid-member-side end 72. Further, body portion 73 is not provided with a fold so as not to be bent at a particular point. This allows body portion 73 to be curved over substantially the entire portion between case-body-side end 71 and lid-member-side end 72.

Next, a closing operation of case 4 of cable linking mechanism 1 according to the present embodiment will be described with reference to FIG. 4A to FIG. 4D as compared with a conventional example in FIG. 6A to FIG. 6D. Note that the following description is merely an example, and the cable linking mechanism of the present invention is not limited to the following description.

In case 4 of cable linking mechanism 1 in the present embodiment, in order to close case body 5 with lid member 6, lid member 6 is rotated relative to case body 5 about hinges 7 (rotation axis X) from the state illustrated in FIG. 4A where case body 5 and lid member 6 are in the open position to the state illustrated in FIG. 4D where case body 5 and lid member 6 are in the closed position. When lid member 6 moves relative to case body 5 in the width direction of case body 5 and away from hinges 7 (rotation axis X) during the rotation relative to case body 5, engaging section 64b protruding and extending outside lid member 6 makes contact with outer wall portion 56 of case body 5, as illustrated in FIG. 4C. This prevents lid member 6 from moving away from hinges 7 (rotation axis X) with respect to case body 5 during the relative rotation, thereby reducing the load applied to hinges 7 and preventing damage to hinges 7. Since engaging section 64b is curved along rotation direction RD of the relative rotation, when lid member 6 is further rotated relative to case body 5 from the state illustrated in FIG. 4C, engaging section 64b rotates while making contact with contact surface 56a of outer wall portion 56 and is guided into through hole TH provided in case body 5. This enables smooth relative rotation of lid member 6, thereby reducing the load on hinges 7 and preventing damage to hinges 7. When lid member 6 is further rotated relative to case body 5, engaging section 64b is guided through through hole TH to engaged section 55b of case body 5, as illustrated in FIG. 4D. When lid member 6 attempts to perform relative movement in a direction perpendicular to sliding surface 51 of case body 5 and away from sliding surface 51 (upper side in FIG. 4D), engaging section 64b that has been guided to engaged section 55b engages with the bottom surface of hinge-side wall portion HW, which is a part of engaged section 55b, thereby restricting the relative rotation of lid member 6 about hinges 7 (rotation axis X) in the direction away from sliding surface 51 of case body 5. This maintains the closed state of case 4. In addition, when lid member 6 attempts to perform relative movement in the width direction of case body 5 toward the hinge 7 side, engaging section 64b engages with the inner surface of hinge-side wall portion HW, which is a part of engaged section 55b, on the through hole TH side, thereby restricting the relative movement of lid member 6 in the width direction of case body 5 toward the hinge 7 side. Accordingly, the closed state of case 4 is maintained, the load on hinges 7 is reduced, and damage to hinges 7 is prevented.

In the state where case body 5 and lid member 6 are in the closed position as illustrated in FIG. 4D, when a load is applied to case body 5 and/or lid member 6 so that lid member 6 moves relative to case body 5 in the direction away from hinges 7 (rotation axis X) (left side in FIG. 4D), outer wall portions 56 of case body 5 and inner wall portions 65 of lid member 6 make contact with each other and restrict the relative movement of lid member 6. For example, a load causing lid member 6 to move relative to case body 5 in the direction away from rotation axis X (hinges 7) is sometimes applied by the snap-fit engagement between third to fifth engaging sections 64c to 64e of lid member 6 (see FIG. 1) and third to fifth engaged sections 55c to 55e of case body 5 (see FIG. 1) when case body 5 and lid member 6 engage with each other. In particular, the lower the temperature of the environment in which cable linking mechanism 1 is placed, the less likely third to fifth engaging sections 64c to 64e and third to fifth engaged sections 55c to 55e deform during the snap-fit engagement, and thus the greater the load causing lid member 6 to move relative to case body 5 becomes. Even in such a case, the contact of outer wall portions 56 with inner wall portions 65 restricts the relative movement between case body 5 and lid member 6, reduces the load applied to hinges 7, and prevents damage to hinges 7.

Here, as illustrated in FIG. 4A to FIG. 4D, outer wall portion 56 that protrudes outside case body 5 is placed on the outer side in the radial direction of the relative rotation of case body 5 and lid member 6 than inner wall portion 65, which is placed inside lid member 6. As a result, as illustrated in FIG. 4C, the rotation path of the end of inner wall portion 65 of lid member 6 on the case body 5 side (see the dashed-and-double-dotted line in the drawing) does not overlap outer wall portion 56 of case body 5. Thus, when case body 5 is closed with lid member 6, the interference (collision) between outer wall portion 56 and inner wall portion 65 is prevented, thereby reducing the load applied to hinges 7 and preventing damage to hinges 7. Further, the clearance between outer wall portion 56 and inner wall portion 65 can be reduced while preventing the interference during the relative rotation, thereby increasing the effect of restricting the relative movement even in the closed state. In contrast, in the conventional example illustrated in FIG. 6A to FIG. 6D, outer wall portion L1 that protrudes outside lid member L is placed on the inner side in the radial direction of the relative rotation of lid member L and case body C than inner wall portion C1, which is placed inside case body C. As a result, as illustrated in FIG. 6B, the rotation path of the end of outer wall portion L1 of lid member L on the case body C side (see the dashed-and-double-dotted line in the drawing) overlaps inner wall portion C1 of case body C. Thus, as illustrated in FIG. 6C, when case body C is closed with lid member L, outer wall portion L1 and inner wall portion C1 interfere (collide) with each other. When outer wall portion L1 and inner wall portion C1 interfere with each other, a load is applied to hinge H and hinge H is possibly damaged. In cable linking mechanism 1 of the present embodiment, outer wall portion 56 that protrudes outside case body 5 is placed on the outer side in the radial direction of the relative rotation than inner wall portion 65, which is placed inside lid member 6, thereby preventing the interference between outer wall portion 56 and inner wall portion 65 and damage to hinges 7.

Further, in cable linking mechanism 1 of the present embodiment, each of hinges 7 is curved over its entire length when lid member 6 is rotated relative to case body 5, as illustrated in FIG. 4B to FIG. 4D. For example, when fold H1 is provided at a substantially center part in the length direction of hinge H as in the conventional example illustrated in FIG. 6A to FIG. 6D, only the substantially center part in the length direction of hinge H is bent with a great curvature, so that the part is locally loaded and easily damaged. Meanwhile, in cable linking mechanism 1 of the present embodiment, hinges 7 are curved over the entire lengths of hinges 7, thereby preventing the curvature from being locally increased and preventing damage to hinges 7.

### REFERENCE SIGNS LIST

1 Cable linking mechanism
21a, 21b Cable
22a, 22b Outer casing
23a, 23b Cable end
3 Connection target
31 One-side engaging section
32 Other-side engaging section
4 Case
5 Case body
51 Sliding surface
52a First side wall
52b Second side wall
52c Cable guiding section
53a Third side wall
53b Fourth side wall
54 Outer casing fixing section
54a Concave section
54b Detachment prevention rib
55a to 55e First to fifth engaged sections
56 Outer wall portion
56a Contact surface
56b Rib
6 Lid member
61 Facing surface
62a Fifth side wall
62b Sixth side wall
63a Seventh side wall
63b Eighth side wall
64a to 64e First to fifth engaging sections
65 Inner wall portion
65a Contact surface
7 Hinge
71 Case-body-side end
72 Lid-member-side end
73 Body portion
HW Hinge-side wall portion
RD Rotation direction
S Internal space
SD Sliding direction
TH Through hole
X Rotation axis

1. A cable linking mechanism, comprising:
a connection target to which a cable is connected; and
a case with internal space slidably accommodating the connection target, wherein:
the case comprises:
a case body with a sliding surface on which the connection target slides;
a lid member capable of closing the case body; and
a hinge that connects the case body and the lid member,
the case body and the lid member are configured to allow relative rotation with respect to each other about the hinge between an open position where the internal space of the case is open and a closed position where the case body is closed with the lid member,
one of the case body and the lid member comprises an outer wall portion that protrudes and extends outward from the one of the case body and the lid member to another one of the case body and the lid member when the case body and the lid member are in the closed position,
the another one of the case body and the lid member comprises an inner wall portion inside in a direction opposite to a direction to the one of the case body and the lid member when the case body and the lid member are in the closed position, the inner wall portion being capable of making contact with the outer wall portion,
the outer wall portion is placed outside from the inner wall portion in a radial direction of the relative rotation, and
the outer wall portion and the inner wall portion are placed to restrict, by making contact with each other, a relative movement of the lid member with respect to the case body along the sliding surface in a direction away from a rotation axis of the relative rotation when the case body and the lid member are in the closed position and a load is applied to the case body and/or the lid member so that the lid member performs the relative movement.

2. The cable linking mechanism according to claim 1, wherein:
the another one of the case body and the lid member comprises an engaging section that engages with the one of the case body and the lid member and protrudes and extends outward from the another one of the case body and the lid member to the one of the case body and the lid member when the case body and the lid member are in the closed position,
the one of the case body and the lid member comprises an engaged section inside in a direction opposite to a direction to the another one of the case body and the lid member when the case body and the lid member are in the closed position, the engaged section being engageable with the engaging section, and
the outer wall portion is placed to guide the engaging section to the engaged section while making contact with the engaging section and restricting the relative movement of the lid member with respect to the case body along the sliding surface in the direction away from the rotation axis when the case body and the lid member perform the relative rotation with respect to each other from the open position to the closed position.

3. The cable linking mechanism according to claim 2, wherein the engaging section is curved in a rotation direction of the relative rotation.

4. The cable linking mechanism according to claim 1, wherein the outer wall portion comprises a rib that extends along a direction of extension of the outer wall portion.

5. The cable linking mechanism according to claim 1, wherein:
the hinge comprises:
a case-body-side end that is connected to the case body;
a lid-member-side end that is connected to the lid member; and
a body portion that extends between the case-body-side end and the lid-member-side end, and
the body portion is formed to be curved over substantially an entire portion between the case-body-side end and the lid-member-side end during the relative rotation of the case body and the lid member with respect to each other.
